(19) United States
(12) Patent Application Publication
(10) Pub. No.: US 2017/0052023 A1
(43) Pub. Date: Feb. 23, 2017

(54) HIGHLY REFLECTIVE SURFACE PROFILE MEASUREMENT SYSTEM WITH AIR CONDENSATION AND METHOD THEREOF

(71) Applicant: INDUSTRIAL TECHNOLOGY RESEARCH INSTITUTE, HSINCHU (TW)

(72) Inventors: Kuo-Feng HUNG, Taoyuan (TW); Chien-Chih CHEN, Taichung (TW)

(21) Appl. No.: 14/872,876

(22) Filed: Oct. 1, 2015

(30) Foreign Application Priority Data
Aug. 17, 2015 (TW) 104126750

(51) Int. Cl. G01B 11/24; F25B 21/02

(52) U.S. Cl. CPC G01B 11/24; F25B 21/02; F25B 2321/023; F25B 2321/0212

(57) ABSTRACT

The present disclosure provides a system and a method thereof for measuring highly reflective surface profile with air condensation. The method, suitable for measuring an article's shiny surface, includes the following steps: reducing the temperature of the air surrounding the article; performing an optical scanning toward the article's surface as to get a photoelectric signal; and processing the signal.

### CROSS-REFERENCE TO RELATED APPLICATIONS

This non-provisional application claims priority under 35 U.S.C. §119(a) on Patent Application No. 104126750 filed in Taiwan, R.O.C. on Aug. 17, 2015, the entire contents of which are hereby incorporated by reference.

### BACKGROUND

Technical Field

The present disclosure relates to a surface profile measurement system and a method thereof, particularly to a highly reflective surface profile measurement system with air condensation and a method thereof.

Description of the Related Art

As the advancement of modern technology, the polishing process enhances the smoothness of varies products. Therefore, those products with high reflectivity have better appearance value. However, the high reflectivity of the products also affects the measurement or inspection result from the optical equipment due to the intensive reflection of light.

### SUMMARY

A highly reflective surface profile measurement system with air condensation is provided which includes a platform, a light source, a photoelectric sensor, at least one thermoelectric cooling module, a controller and a processor. The light source projects an incident light. The photoelectric sensor receives a reflected/refracted light and converts the reflected/refracted light to an electrical signal. The at least one thermoelectric cooling module further includes a cooling plate. The controller is electrically connected to the light source, the photoelectric sensor and the thermoelectric cooling module respectively as to drive the light source, the photoelectric sensor and the thermoelectric cooling module. The processor is electrically connected to the controller to receive and process the electrical signal.

Another highly reflective surface profile measurement system with air condensation is also provided which includes a platform, a light source, a photoelectric sensor, a cooling air outlet, a controller and a processor. The platform further includes a cold room. The light source projects an incident light. The photoelectric sensor receives a reflected/refracted light and converts the reflected/refracted light to an electrical signal. The cooling air outlet outputs a cold air to the cold room. The controller is electrically connected to the light source, the photoelectric sensor and the cooling air outlet respectively as to drive the light source, the photoelectric sensor and the cooling air outlet. The processor is electrically connected to the controller to receive and process the electrical signal.

A highly reflective surface profile measurement method with air condensation is also provided for measuring a surface of an article includes the steps: reducing the temperature of the air surrounding the article, performing an optical scanning to the surface of the article to obtain an electrical signal, and processing the electrical signal.

Another highly reflective surface profile measurement system with air condensation is also provided which includes a platform, a light source, a photoelectric sensor, a front cooling air outlet, a rear cooling air outlet, a controller and a processor. The platform further includes a front cold room and a rear cold room. The light source projects an incident light. The photoelectric sensor receives a reflected/refracted light and converts the reflected/refracted light to an electrical signal. The front cooling air outlet outputs a cold air to the front cold room. The rear cooling air outlet outputs another cold air to the rear cold room. The controller is electrically connected to the light source, the photoelectric sensor, the front cooling air outlet and the rear cooling air outlet respectively as to drive the light source, the photoelectric sensor, the front cooling air outlet and the rear cooling air outlet. The processor is electrically connected to the controller to receive and process the electrical signal.

The contents of the present disclosure set forth and the embodiments hereinafter are for demonstrating and illustrating the spirit and principles of the present disclosure, and for providing further explanation of the claims.

### BRIEF DESCRIPTION OF THE DRAWINGS

The present disclosure will become more fully understood from the detailed description given herein below and the accompanying drawings, which are given by way of illustration only and thus are not limitative of the present disclosure and wherein:

FIGS. 1A and 1B are diagrams of the specular reflection and the diffuse reflection;

FIG. 2 is a diagram of generating the diffuse reflection with an incident light passing through a water droplets;

FIG. 3 is a flowchart of the surface profile measurement method with air condensation;

FIG. 4 is a structural diagram of the surface profile measurement system with air condensation according to an embodiment;

FIG. 5 is a structural diagram of the surface profile measurement system with air condensation according to another embodiment; and

FIG. 6 is a structural diagram of the surface profile measurement system with air condensation according to a further embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

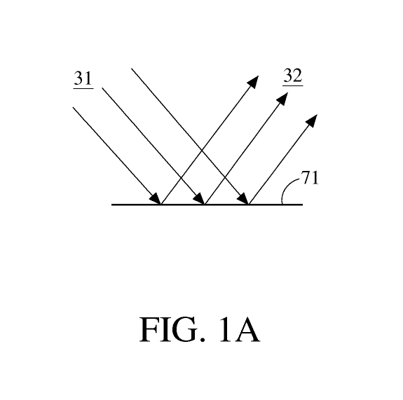

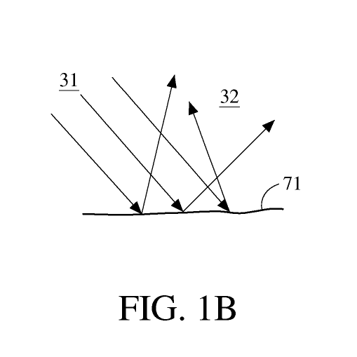

FIG. 1A is a diagram of the specular reflection. When a parallel incident light 31 emits toward the surface 71, straight or curved, of an article at a single incident angle, a reflected light 32 at the same angle occurs on the opposite side according to the normal line of the surface. The reflected light 32 normally has strong intensity especially when the surface has higher smoothness or lower roughness. If the reflected light 32 with strong intensity entering an optical measurement equipment without any filter will cause damages to the equipment. However, on the other hand, if the surface has higher roughness or lower smoothness, as shown in FIG. 1B, a diffuse reflection at different reflection angles with weaker intensity can be captured by the equipment for obtaining a better measurement result on surface profile or defect inspection.

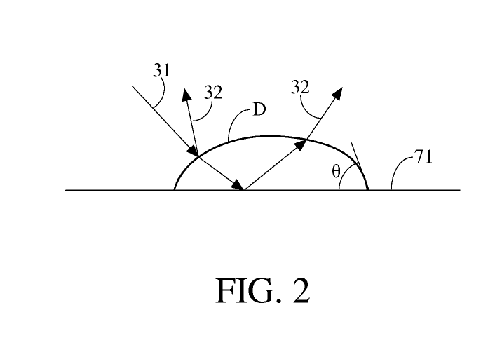

FIG. 2 is a diagram of generating the diffuse reflection with an incident light passing through the water droplets for explaining the method of enhancing the roughness of the article surface temporarily. For some articles, such as faucet or other bathroom hardware, no matter the material is metal or non metal, the surface 71 is highly smooth after multiple polishing or electroplating, so that the characteristic creates a measuring or inspecting problem for non-contact optical measurement equipment. One embodiment of the present disclosure temporarily forms a thin layer of water droplets on the surface, so that the incident light 31 emits towards the water droplet D and creates a plurality of reflections and refractions. The reflected light 32 has different reflecting angles which forms the diffuse reflection. Therefore, the roughness of the surface is enhanced for obtaining and processing the optical information. The embodiment is for illustrating with the water droplets but not for limiting the present disclosure.

Using water droplets or other liquid to create a thin layer on the article surface creates different contact angles because of different roughness and surface tension, so that the reflecting angles are changed accordingly. As shown in FIG. 2, a suitable selection of the contact angle refers to the material of the article, the surface of the article, and the measurement process. The present disclosure uses water for forming a thin layer of water droplets mainly because there is no additional process or facility to remove away the water droplets and water droplets will be vaporized to the air after the measurement. Other liquid, such as methanol, is also acceptable when the contact angle is qualified. A smaller contact angle θ causes wetting phenomenon on the surface and the smoothness of the article surface is not effectively lowered. However, the droplets are not firmly attached on the surface due to a greater contact angle.

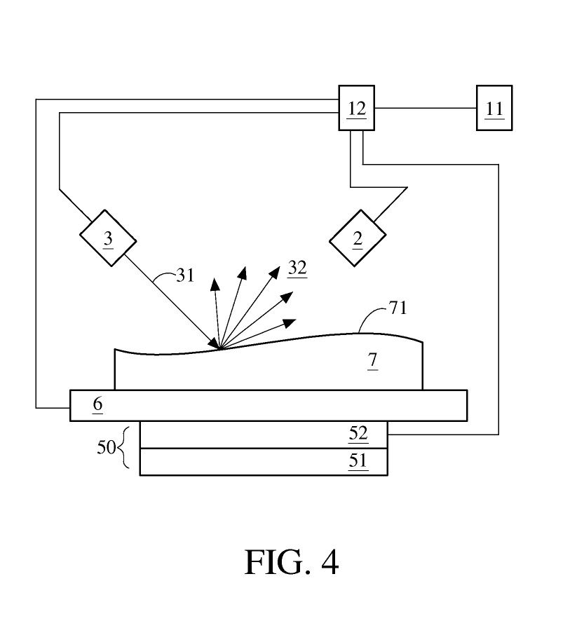

Please refer to FIG. 4 first. FIG. 4 is a structural diagram of the surface profile measurement system with air condensation according to an embodiment. The system includes a platform 6 or a conveyer table on which the article 7 having the surface 71 is placed, a photoelectric sensor 2, a light source 3, at least one thermoelectric cooling module 50 contacting with the article 7 directly or indirectly, and a processor 11. The processor 11 is at least electrically connected to the photoelectric sensor 2, the light source 3, and the thermoelectric cooling module 50, and is for performing driving control, information collecting and processing. If the platform 6 has moving or rotating functions, the platform 6 has to be electrically connected to the controller 12. However, if the platform 6 is fixed, the photoelectric sensor 2 or the light source 3 has to moves relatively to finish scanning. The light source 3 and the photoelectric sensor 2 can be physically combined together as a single equipment. The present embodiment illustrates the numbers and names of the components but not limits the present disclosure.

As shown in FIG. 4 again, the thermoelectric cooling module 50 includes a heating plate 51 and a cooling plate 52. The cooling plate 52 is connected or installed under or above the platform 6, or the cooling plate 52 is arranged to create a close or open space for placing the article 7, or the cooling plate 52 directly contacts the article 7, to form an effective heat conductivity to cool down the article or the temperature of the air surrounding the article.

When the article 7 is finished and is placed on the platform 6, the processor 11 orders the controller 12 to drive the thermoelectric cooling module 50 to create the Peltier-Seebeck effect. The cooling plate 52 directly or indirectly cools down the article 7 and the surrounding air. No matter whether the article 7 is an effective thermal conductor, the water in the air is condensed on the surface 71 and forms the thin layer of water droplets D. The diameter of a water droplet D is approximately 0.1˜2 μm depending on the practical condition, and evenly and steadily spreading the water droplets on the surface 71 is necessary. The light source 3 is driven to emit the incident light 31 towards the surface 71. The incident light 31 is, for example, a blue light or a red light. After the reflection of the water droplets D, the reflected/refracted light 32 enters the photoelectric sensor 2 and is converted to an electrical signal. The electrical signal is sent to the processor 11 for further processing, such as generating the point cloud of the article 7 or inspecting the defects on the surface 71. The present embodiment is for illustrating but not for limiting the present disclosure. If the platform 6 is a conveyer table, the light source 3 and the photoelectric sensor 2 can be placed on different locations to operate individually for multiple articles 7.

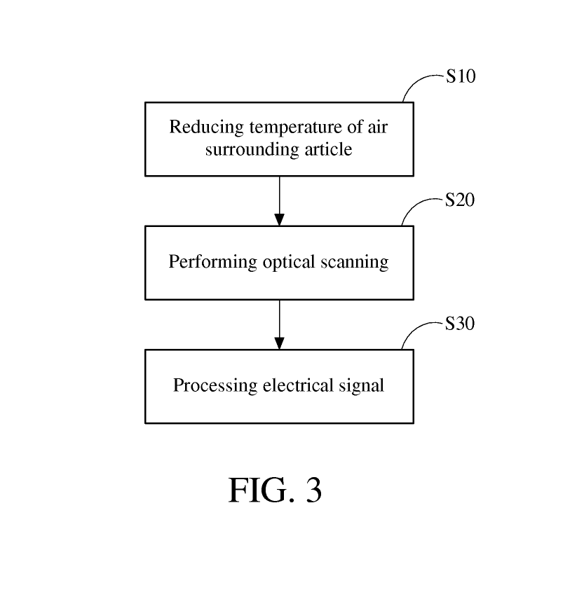

FIG. 3 is a flowchart of the surface profile measurement method with air condensation. As shown in FIG. 3, in the step S10, the temperature of article surface or the air surrounding the article is reduced to form the water droplets on the article surface, and the water droplets on the surface have adequate contact angles, so that the water droplets are evenly and steadily attached on the surface. When the water droplets are formed, in the step S20, an optical scanning is performed to the surface of the article to obtain an electrical signal. By projecting the incident light to the article's surface with the optical equipment and receiving the reflected/refracted light, the information related to the surface in the reflected/refracted light is converted to the electrical signal. In the step S30, the electrical signal is processed to obtain information of the surface, such as shapes, defects, or point clouds. The present embodiment is for illustrating but not for limiting the present disclosure.

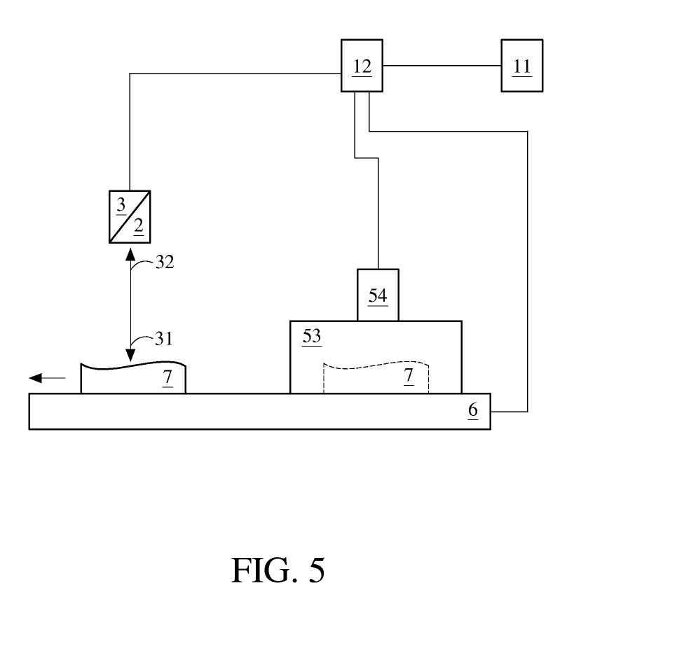

FIG. 5 is a structural diagram of the surface profile measurement system with air condensation according to another embodiment. The difference between the system in FIG. 4 and FIG. 5 is that the thermoelectric cooling module 50 is removed in FIG. 5 and an open or closed cold room 53 is placed on the platform 6. The controller 12 controls an air conditioning equipment (not shown), so that the cooling air outlet 54 is sending cold air to cool down the article 7 placed in the cold room 53 directly or indirectly. The thin layer of water droplets D is formed on the surface 71 because the surrounding temperature is lowered. The cold air indicates the air which has lower temperature than the exterior air or the air surrounding the photoelectric sensor 2. Similarly, if the platform 6 is a conveyer table, the measurement method with air condensation is executed successively.

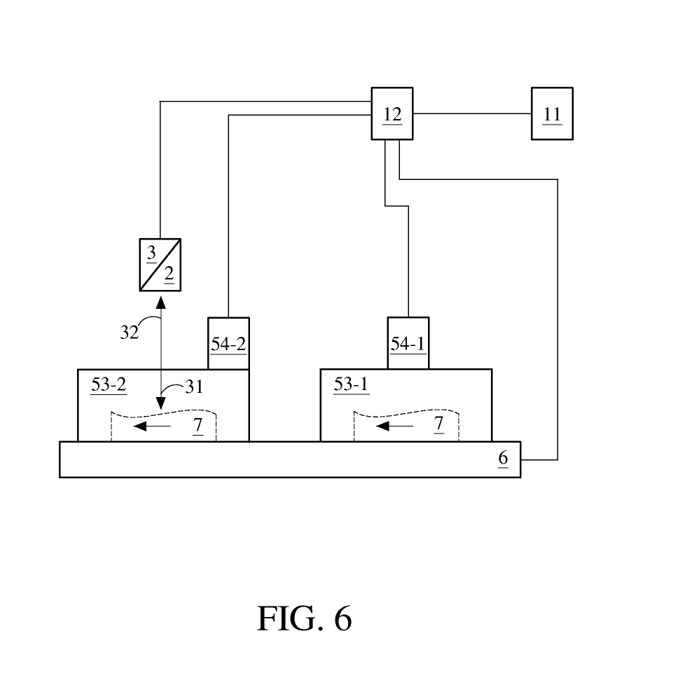

FIG. 6 is a structural diagram of the surface profile measurement system with air condensation according to a further embodiment. The difference between the system in FIG. 5 and FIG. 6 is that the front cold room 53-1 and the rear cold room 53-2 are installed on the platform 6 in FIG. 6. The front and rear positions of the two cold rooms on the platform 6 depend on the order of the article 7 when entering the cold rooms as the platform 6 moves, but the article 7 does not move or rotate with the platform 6. The temperature and humidity are respectively controlled by the cold air outputted from the front cooling air outlet 54-1 and the rear cooling air outlet 54-2 of the air conditioning equipment controlled by the controller 12. For example, the temperature of the front cold room 53-1 is 260˜300 Kelvin (K) and the humidity of the front cold room 53-1 is 0˜80% Relative Humidity (RH), and the temperature of the rear cold room 53-2 is 273˜373 K and the humidity of the rear cold room 53-2 is 20˜100% RH. The present embodiment is for illustrating but not for limiting the present disclosure. By providing two different temperature and humidity conditions, the article 7 is first kept in the front cold room 53-1 and then in the rear cold room 53-2 for a certain time to form the thin layer of water droplets D on the surface 71. The two cold rooms can be open/closed and connected/separated. If the platform 6 is rotatable or movable, the measurement method with air condensation can be executed successively.

The purpose of forming a thin layer of water droplets on the high smooth surface of an article provided in the present disclosure is to avoid the reflection of the parallel incident light to the optical equipment. The water droplets can be vaporized later without any additional process, and the process of spreading hydrophobe, hydrophile, or fluorescent agent on the surface in advance is also avoided. Therefore, the correctness and convenience of the measurement process for the highly reflective surface are achieved. Taking bathroom hardware as processed article for example, the present disclosure enhances more than 80% of point clouds in number.

The foregoing description has been presented for purposes of illustration. It is not exhaustive and does not limit the disclosure to the precise forms or embodiments disclosed. Modifications and adaptations will be apparent to those skilled in the art from consideration of the specification and practice of the disclosed embodiments of the disclosure. It is intended, therefore, that the specification and examples be considered as exemplary only, with a true scope and spirit of the disclosure being indicated by the following claims and their full scope of equivalents.

What is claimed is:

1. A highly reflective surface profile measurement system with air condensation, comprising:
a platform;
a light source configured to project an incident light;
a photoelectric sensor configured to receive a reflected/refracted light and converting the reflected/refracted light to an electrical signal;
at least one thermoelectric cooling module further comprising a cooling plate;
a controller electrically connected to the light source, the photoelectric sensor and the thermoelectric cooling module respectively, is configured to drive the light source, the photoelectric sensor and the thermoelectric cooling module; and
a processor electrically connected to the controller to receive and process the electrical signal.

2. The system of claim 1, wherein the controller is further electrically connected to the platform to drive the platform to move or rotate.

3. The system of claim 1, wherein the cooling plate is connected to the platform to form thermal conductivity.

4. A highly reflective surface profile measurement system with air condensation, comprising:
a platform further comprising a cold room;
a light source configured to project an incident light;
a photoelectric sensor configured to receive a reflected/refracted light and converting the reflected/refracted light to an electrical signal;
a cooling air outlet configured to output a low temperature air to the cold room;
a controller electrically connected to the light source, the photoelectric sensor and the cooling air outlet respectively, is configured to drive the light source, the photoelectric sensor and the cooling air outlet; and
a processor electrically connected to the controller to receive and process the electrical signal.

5. The system of claim 4, wherein the controller is further electrically connected to the platform to drive the platform to move or rotate.

6. A highly reflective surface profile measurement method with air condensation for measuring a surface of an article, comprising:
reducing the temperature of the air surrounding the article;
performing an optical scanning to the surface of the article to obtain an electrical signal; and
processing the electrical signal.

7. The method of claim 6, wherein the optical scanning is projecting an incident light to the surface of the article and receiving a reflected/refracted light.

8. A highly reflective surface profile measurement system with air condensation, comprising:
a platform further comprising a front cold room and a rear cold room;
a light source configured to project an incident light;
a photoelectric sensor configured to receive a reflected/refracted light and convert the reflected/refracted light to an electrical signal;
a front cooling air outlet configured to output cold air to the front cold room;
a rear cooling air outlet configured to output another cold air to the rear cold room;
a controller electrically connected to the light source, the photoelectric sensor, the front cooling air outlet and the rear cooling air outlet respectively, is configured to drive the light source, the photoelectric sensor, the front cooling air outlet and the rear cooling air outlet; and
a processor electrically connected to the controller to receive and process the electrical signal.

9. The system of claim 8, wherein the controller is further electrically connected to the platform to drive the platform to move or rotate.

10. The system of claim 8, wherein the temperature of the front cold room is different from the temperature of the rear cold room.

11. The system of claim 8, wherein the humidity of the front cold room is different from the humidity of the rear cold room.
